(19) United States
(12) Patent Application Publication
(10) Pub. No.: US 2009/0115499 A1
(43) Pub. Date: May 7, 2009

(54) Capacitance coupling effect compensating method and apparatus implemented with the method

(76) Inventors: Ting-Chen Chiu, Tainan (TW); Hsu-Ho Wu, Tainan (TW); Wen-Chen Rang, Tainan (TW); Chun-Chin Tseng, Kaohsiung (TW)

Correspondence Address: Nixon Peabody LLP, 200 Page Mill Road, Suite 200, Palo Alto, CA, 94306, US

(21) Appl. No.: 12/030,881

(22) Filed: Feb. 14, 2008

(30) Foreign Application Priority Data
Nov. 2, 2007 (TW) 096141548

(51) Int. Cl. G05F 1/10

(52) U.S. Cl. 327/538

(57) ABSTRACT

An electronic apparatus implemented with capacitance coupling effect compensating capability is disclosed. The apparatus includes a first substrate, a common electrode, a second substrate, a coupling catch structure and a compensating circuit. The common electrode is disposed on the first substrate. The coupling catch structure is disposed on the second substrate and configured to receive a first common voltage and output a coupling catch voltage composed of a DC voltage component and a non-DC voltage component. The compensating circuit is configured to receive the coupling catch voltage and a second common voltage, and output an active common voltage applied to the common electrode. The present invention also includes a capacitance coupling effect compensating method.

### BACKGROUND OF THE INVENTION

1. Field of the Invention

The present invention is related to a compensating method for electrical coupling effect, and more particularly, related to a compensating method for capacitance coupling effect and an electrical device implemented with the same.

2. Description of the Prior Art

Some electrical devices, such as a display device, are usually needed to provide a stable DC voltage level to maintain their operation. For example, as to a thin film transistor liquid crystal display (TFT LCD), a stable DC voltage is provided at the system circuit board and used to be a common reference voltage of the display circuit in the circuit board. However, there is a ripple effect in the common reference voltage caused by the capacitance coupling effect of the display substrate, the voltage level of the common reference voltage is unstable and the quality of the display picture is decreased.

FIG. 7 is a view showing a conventional LCD panel 700 structure. The LCD panel 700 includes a substrate 720, a first driving circuit 750, a second driving circuit 760 and some shunt capacitors C1 and C2. The capacitors C1 and C2 are often used as filtering capacitors to stable the capacitance coupling effect, however, they have poor effectiveness that the capacitance coupling effect still exists and it decreases the quality of the display picture. So, the problems of capacitance coupling effect shown in FIG. 7 are still needed to solve.

According to the described above, there is a need to provide a better capacitance coupling effect compensating method to solve the problem in the LCD panel.

### SUMMARY OF THE INVENTION

According to the problems described above, an electronic apparatus implemented with capacitance coupling effect compensating capability is disclosed in one embodiment of the present invention, and includes a first substrate, a common electrode, a second substrate, a coupling catch structure and a compensating circuit. The common electrode is disposed on the first substrate. The second substrate is configured to receive a first common voltage. The coupling catch structure is disposed on the second substrate and configured to output a coupling catch voltage. And the compensating circuit is configured to receive the coupling catch voltage and output an active common voltage to the common electrode.

According to another embodiment of the present invention, a compensating method is used in an electronic apparatus with capacitance coupling effect, and the electronic apparatus includes a first substrate, a second substrate and a common electrode generated on the first substrate and includes the step of providing a first common voltage in the second substrate, the step of providing a coupling catch structure disposed on the second substrate and configured to output a coupling catch voltage and the coupling catch structure includes a DC voltage and a non-DC voltage, the step of coupling the inverse phase of the non-DC voltage to a second common voltage and generate an active common voltage, and the step of implementing the active common voltage to the common electrode.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a view illustrating a main structure of a liquid crystal display (LCD) device with capacitance coupling effect compensating function.

FIG. 2A is a view illustrating a coupling catch voltage with DC voltage and non-DC voltage.

FIG. 2B is a view illustrating a reverse phase non-DC voltage generated by filtering the DC voltage of the coupling catch voltage and reversing the non-DC voltage and adding some gain in the non-DC voltage.

FIG. 2C is view illustrating an active common voltage is generated by adding the non-DC voltage on the second common voltage.

FIG. 3 is a view illustrating a LCD structure with coupling catch structure according to one embodiment of the present invention.

FIG. 4 is a view illustrating a capacitance coupling effect compensating method using in an electronic device according to one embodiment of the present invention.

FIG. 5 is a view illustrating a capacitance coupling effect compensating method using in an electronic device according to another embodiment of the present invention.

FIG. 6 is a view illustrating a capacitance coupling effect compensating method using in an electronic device according to other embodiment of the present invention.

FIG. 7 is a view illustrating a conventional LCD panel.

### DESCRIPTION OF THE PREFERRED EMBODIMENT

Some sample embodiments of the invention will now be described in greater detail. Nevertheless, it should be recognized that the present invention can be practiced in a wide range of other embodiments besides those explicitly described, and the scope of the present invention is expressly not limited except as specified in the accompanying claims.

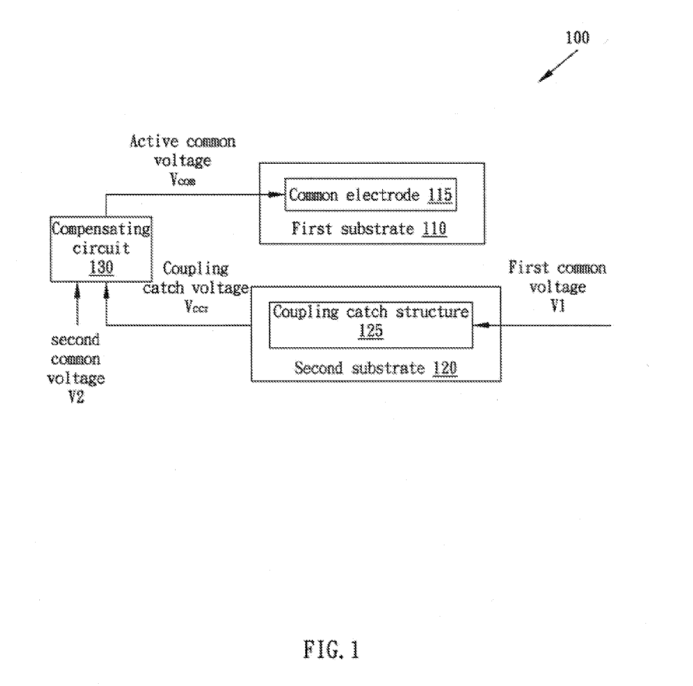

Please refer to FIG. 1 and it is a view showing that a liquid crystal display (LCD) device 100 with a built-in capacitance coupling effect compensating function according to an embodiment of the present invention. The LCD device 100 includes a first substrate 110, a common electrode 115, a second substrate 120, a coupling catch structure 125 and a compensating circuit 130. The common electrode 115 is disposed on the first substrate 110. The coupling catch structure 125 is disposed on the second substrate 120. The common electrode 115 on the first substrate 110 can be disposed at different wire layout in accordance with the production requirement. The coupling catch structure 125 on the second substrate 120 can be any wire layout or circuit. There are some other components, such as color filter, disposed on the first substrate 110 (not shown), so the first substrate 110 is also called a color filter (CF) substrate. There are some data lines and scan lines used to be the display unit array of the TFT and disposed on the second substrate 120. The second substrate 120 is also called Array substrate. There are some infillings disposed between the first substrate 110 and the second substrate 120. There is a circuit board (not shown) used to dispose the driving circuit elements on the LCD device 100. The compensating circuit 130 in the present embodiment is disposed on the circuit board. The detail description will be shown in the following paragraph.

The coupling catch structure 125 receives a first common voltage V1 and outputs a coupling catch voltage Vcct. The compensating circuit 130 receives a second common voltage V2 and the coupling catch voltage Vcct outputted from the coupling catch structure 125, and outputs an active common voltage Vcom to the common electrode 115 on the first substrate 110. The first common voltage V1 and the second common voltage V2 are the DC voltage with specific voltage level, but the voltage level of the first common voltage V1 and the second common voltage V2 can be different. The compensating catch voltage Vcct includes a stable DC voltage Vdc and an unstable non-DC voltage Vac caused by the capacitance coupling effect between the first substrate 110 and the second substrate 120. The stable DC voltage Vdc is the DC voltage level of the first common voltage V1. The unstable AC voltage Vac is the periodic or non-periodic unstable signal caused by any different kinds of capacitance coupling effect.

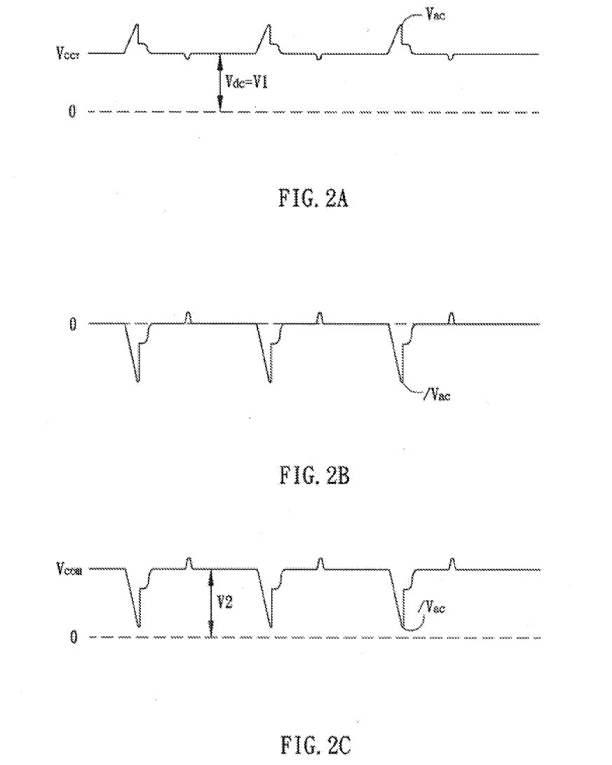

The function of the compensating circuit 130 is to catch the non-DC voltage Vac within the coupling catch voltage Vcct, then reverse the phase of the non-DC voltage Vac and amplifying the voltage of the phase-reversed non-DC voltage by a certain gain to form a phase-reverse non-DC voltage Vac′. The Vac′ is the phase-reversed and amplified signal of the Vac. So the Vac′ is also a periodic or non-periodic unstable signal. Subsequently, the phase-reverse non-DC voltage Vac′ is added to the second common voltage V2 to output the active common voltage Vcom. FIGS. 2A-2C are views of a sample of the coupling catch voltage Vcct and showing how to catch the non-DC voltage via the compensating circuit 130 and further reverse the phase of the non-DC voltage to get an another non-DC voltage. As shown in FIG. 2A, the coupling catch voltage Vcct is composed of the DC voltage Vdc and the non-DC voltage Vac. The DC voltage Vdc is the DC voltage level of the first common voltage V1. As shown in FIG. 2B, the phase of non-DC voltage Vac is reversed and then the phase-reversed non-DC voltage is amplified to generate a non-DC voltage Vac′. As shown in FIG. 2C, it is coupling a DC voltage V2 with the non-DC voltage Vac′ to generate the active common voltage Vcom. Therefore, the active common voltage Vcom is composed by the DC voltage V2 and the non-DC voltage Vac′. It should be noted by the person with original skilled in the art that the compensating circuit 130 is made in accordance with an amplifier, an inverter, a coupled device and some active or passive components.

The coupling catch structure 125 includes a conductive wire layout or a circuit structure and is used to detect the combinative influence of the capacitance coupling effect occurred between the first substrate 110 and the second substrate 120. The combinative influence of the capacitance coupling effect will generate an unstable non-DC voltage Vac on the first common voltage V1. The wire layout of the coupling catch structure 125 according to the production requirement can be a straight line, a curved line, a dot structure, a net structure and so on. The circuit structure used to form the coupling catch structure 125 is made by some regular active or passive components. In a single LCD device, there is one or more coupling catch structure 125 in accordance with the common electrode 115 used to recover a portion of the capacitance coupling effect.

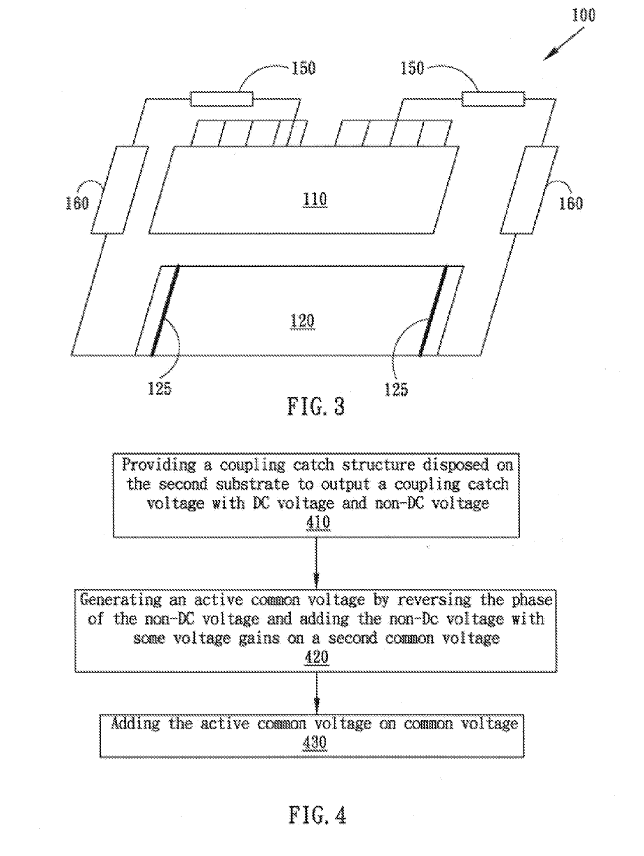

FIG. 3 is a view showing a LCD panel 100 with coupling catch structure 125 in accordance with one embodiment of the present invention. The LCD panel 100 includes a CF substrate 110 (as the first substrate shown in FIG. 1), an array substrate 120 (as the second substrate shown in FIG. 1), a coupling catch structure 125, a first circuit board 150 and a second circuit board 160. In the present embodiment, the coupling catch structure 125 is formed as the conductive wire layout or the circuit vertically located in the two sides of the array substrate 120. The coupling catch voltage Vcct generated by the coupling catch structure 125, and the coupling catch voltage Vcct couples to the compensating circuit 130 (not shown) of the first circuit board 150 and/or the second circuit board 160 generating an active common voltage Vcom, and then the active common voltage Vcom inputs to the common electrode 115 opposite to the CF substrate 110. The layout of the coupling catch structure 125 can be a straight line or any other geometric shape and the direction of the coupling catch structure 125 can be vertical or any others direction.

The coupling catch structure 125 can be corresponding to one or more TFT display units in accordance with the production requirement. For example, when there is a serious capacitance coupling problem in specific positions of the LCD panel, a suitable number of the coupling catch structures 125 can be used to dispose on the specific positions of the LCD panel. An active common voltage Vcom is generated according to the method described above in the position corresponding to the common electrode 115 of the specific position to overcome or reduce the capacitance coupling effect.

FIG. 4 showing a method for compensating the capacitance coupling effect of the electronic device according to one embodiment of the present invention. The method is used in an electronic device which includes a first substrate 110, a second substrate 120 and a common electrode 115 disposed on the first substrate 110. As the description in the present embodiment, the reference numbers of the components in FIG. 1 are reused herein. First of all, in step 410, the present embodiment is to provide a coupling catch structure 125. The coupling catch structure 125 is disposed on the second substrate 120 and used to receive a first common voltage V1 and output a coupling catch voltage Vcct. The coupling catch voltage Vcct includes a DC voltage Vdc and a non-DC voltage Vac. As the description above, the non-DC voltage Vac is generated by the capacitance coupling effect between the first substrate 110 and the second substrate 120 and is a periodic or non periodic unstable noise signal.

In step 420, the non-DC voltage Vac′ is generated by reversing the non-DC voltage Vac to have an reversing phase and amplifying voltage by a certain gain, then the non-DC voltage Vac′ is coupled with a second common voltage V2 to generate an active common voltage Vcom. Therefore, the active common voltage Vcom is composed by a DC voltage V2 and a non-DC voltage Vac′. For example, the compensating circuit 130 in FIG. 1 can accomplish the step 420.

In step 430, the active common voltage Vcom is coupled to the common electrode 125. The active common voltage Vcom includes non-DC voltage Vac′ used to compensate the capacitance coupling effect to overcome or reduce the negative effect generated by the capacitance coupling effect.

FIG. 5 is showing a method for compensating the capacitance coupling effect of the electronic device in another embodiment of the present invention. As shown in FIG. 5, in step 510, it is providing a first common voltage and adding the first common voltage in the second substrate. The same as the embodiment in FIG. 4, there is a coupling catch structure disposed on the second substrate. In step 520, a coupling catch voltage is outputted from the coupling catch structure disposed on the second substrate. In step 530, it is inputting the coupling catch voltage to the compensating circuit. Finally, in step 540, a common voltage outputted from the compensating circuit is inputted to the common electrode so as to overcome or reduce the capacitance coupling effect.

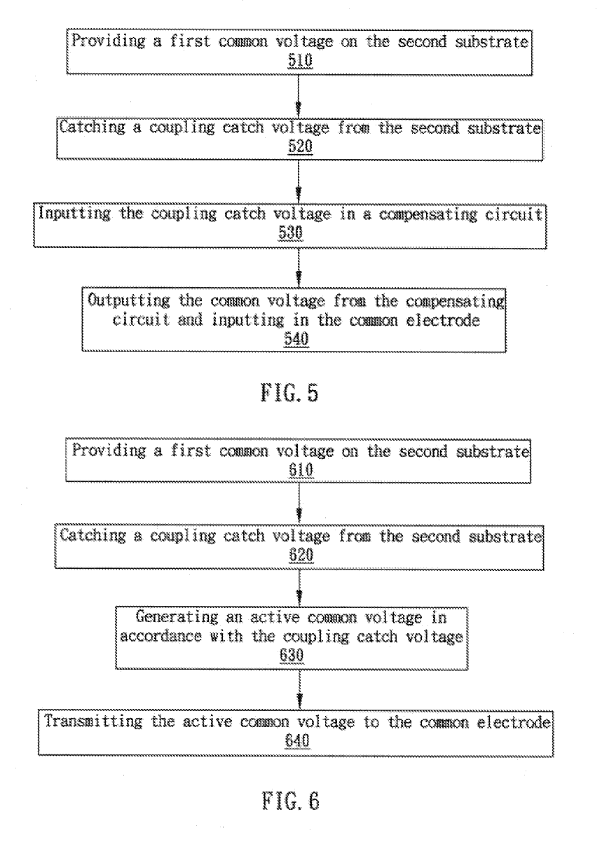

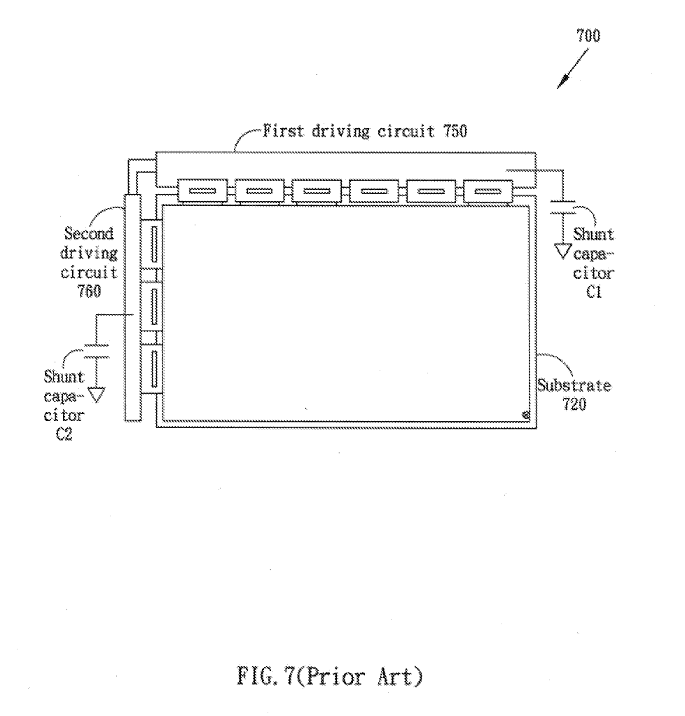

FIG. 6 is showing one embodiment of this invention. In step 610, it includes providing a first common voltage and adding the first common voltage to the second substrate. The same as the embodiment in FIG. 4, there is a coupling catch structure disposed on the second substrate. In step 620, a coupling catch voltage is outputted from the coupling catch structure disposed on the second substrate. In step 630, an active common voltage is generated in accordance with the coupling catch voltage. Finally, in step 640, the active common voltage is transmitted to the common electrode so as to overcome or reduce the capacitance coupling effect.

Although specific embodiments have been illustrated and described, it will be obvious to those skilled in the art that various modifications may be made without departing from what is intended to be limited solely by the appended claims.

What is claimed is:

1. An electronic apparatus with capacitance coupling effect compensating capability comprising:
a first substrate;
a common electrode disposed on the first substrate;
a second substrate configured to receive a first common voltage;
a coupling catch structure disposed on the second substrate and configured to output a coupling catch voltage; and
a compensating circuit configured to receive the coupling catch voltage and output an active common voltage to the common electrode.

2. The electronic apparatus with capacitance coupling effect compensating capability according to claim 1, wherein the compensating circuit is further configured to receive a second common voltage, and output the active common voltage in accordance with the coupling catch voltage and the second common voltage.

3. The electronic apparatus with capacitance coupling effect compensating capability according to claim 2, wherein the active common voltage is generated by the second common voltage plus a signal which is generated by reversing and amplifying the non-DC voltage of the coupling catch voltage.

4. The electronic apparatus with capacitance coupling effect compensating capability according to claim 1, wherein the coupling catch voltage is generated by the capacitance coupling effect occurred between the first substrate and the second substrate.

5. The electronic apparatus with capacitance coupling effect compensating capability according to claim 1, wherein the coupling catch voltage includes a first DC voltage and a first non-DC voltage.

6. The electronic apparatus implemented with capacitance coupling effect compensating capability according to claim 5, wherein the active common voltage includes a second DC voltage and a second non-DC voltage.

7. The electronic apparatus implemented with capacitance coupling effect compensating capability according to claim 6, wherein the first non-DC voltage and the second non-DC voltage are opposite in phase.

8. The electronic apparatus implemented with capacitance coupling effect compensating capability according to claim 1, wherein the coupling catch structure includes a conductive line or a circuit.

9. The electronic apparatus implemented with capacitance coupling effect compensating capability according to claim 1, wherein the electronic apparatus is a liquid crystal display (LCD).

10. The electronic apparatus implemented with capacitance coupling effect compensating capability according to claim 2, wherein the first common voltage is equal to the second common voltage.

11. The electronic apparatus implemented with capacitance coupling effect compensating capability according to claim 1, wherein the compensating circuit includes an amplifier, an inverter and a coupled device.

12. A method for compensating electronic apparatus with capacitance coupling effect, wherein the electronic apparatus including a first substrate, a second substrate and a common electrode disposed on the first substrate, comprising:
providing a first common voltage to the second substrate;
providing a coupling catch structure disposed on the second substrate and configured to receive a first common voltage and output a coupling catch voltage, and the coupling catch voltage includes a DC voltage and a non-DC voltage;
generating an active common voltage by coupling a signal generated by reversing and amplifying the non-DC voltage of the coupling catch voltage to a second common voltage; and
transmitting the active common voltage to the common electrode.

13. The method for compensating electronic apparatus with capacitance coupling effect according to claim 12, wherein the electronic apparatus is a liquid crystal display (LCD).

14. The method for compensating electronic apparatus with capacitance coupling effect according to claim 12, wherein the active common voltage is generated by a compensating circuit.

15. The method for compensating electronic apparatus with capacitance coupling effect according to claim 12, wherein the first common voltage is equal to the second common voltage.

16. A method for compensating electronic apparatus with capacitance coupling effect, wherein the electronic apparatus including a first substrate, a second substrate and a common electrode disposed on the first substrate, comprising:
providing a first common voltage inputs to the second substrate;
outputting a coupling catch voltage from the second substrate, wherein the coupling catch voltage includes a first DC voltage and a first non-DC voltage;
generating an active common voltage in accordance with the coupling catch voltage, wherein the active common voltage includes a second DC voltage and a second non-DC voltage, and the second non-DC voltage and the first non-DC voltage are opposite in phase; and
transmitting the active common voltage to the common electrode disposed on the first substrate.

17. The method for compensating electronic apparatus with capacitance coupling effect according to claim 16, wherein the first DC voltage is provided by the first common voltage.

18. The method for compensating electronic apparatus with capacitance coupling effect according to claim 16 further comprising the active common voltage is generated in accordance with a second common voltage.

19. The method for compensating electronic apparatus with capacitance coupling effect according to claim 18, wherein the second DC voltage is provided by the second common voltage.

20. The method for compensating electronic apparatus with capacitance coupling effect according to claim 16 further comprising the step of coupling the reverse phase of the first non-DC voltage with a second common voltage and generating an active common voltage.

21. The method for compensating electronic apparatus with capacitance coupling effect according to claim 16, wherein the first common voltage is equal to the second common voltage.

22. A method for compensating electronic apparatus with capacitance coupling effect, wherein the electronic apparatus including a first substrate, a second substrate and a common electrode disposed on the first substrate, comprising:
providing a first common voltage inputs to the second substrate;
outputting a coupling catch voltage from the second substrate;
generating an active common voltage in accordance with the coupling catch voltage from a compensating circuit; and
transmitting the active common voltage to the common electrode.

23. The method for compensating electronic apparatus with capacitance coupling effect according to claim 22, wherein the coupling catch voltage includes a DC voltage and a non-DC voltage.

24. The method for compensating electronic apparatus with capacitance coupling effect according to claim 22, wherein the coupling catch voltage is generated in accordance with the capacitance compensating effect occurred between the first substrate and the second substrate.

25. The method for compensating electronic apparatus with capacitance coupling effect according to claim 22, wherein the active common voltage is generated in accordance with the phase reverse of the coupling catch voltage coupling to a second common voltage.
